(19) United States
(12) Patent Application Publication
(10) Pub. No.: US 2005/0102895 A1
(43) Pub. Date: May 19, 2005

(54) Soil-less seed support medium and method for germinating a seed

(76) Inventors: W. Michael Bissonnette, Boulder, CO (US); John Thompson, Longmont, CO (US)

Correspondence Address: Laura L Conley, 900 28th Street, Suite #201, Boulder, CO, 80303, US

(21) Appl. No.: 10/714,786

(22) Filed: Nov. 17, 2003

(51) Int. Cl. A01C 1/06

(52) U.S. Cl. 47/57.6

(57) ABSTRACT

A soil-less seed support medium comprising a seed-bearing substrate superposed upon a cellular substrate contained within a rigid, porous cup-shaped modular receptacle is disclosed. Alternatively, a seed support medium comprising a seed-bearing cellular substrate contained within a rigid, porous cup-shaped modular receptacle is disclosed. Both embodiments are modular in design for ease in packaging, shipping, implanting and transplanting. A method for germinating a seed utilizing the seed support medium is also disclosed.

### FIELD OF THE INVENTION

The present invention relates to the field of seed support and germination and more particularly to seed support and germination in an aeroponic or hydroponic system.

### BACKGROUND OF THE INVENTION

Soil-less cultivation of plants can provide many advantages over traditional soil-based cultivation. In a soil-less medium, delivery of nutrients to plant roots can be regulated more easily in order to optimize plant growth. This is done by precisely controlling the composition of a nutrient solution, and then by controlling precisely the frequency that plant roots are exposed to the nutrient solution. Theoretically, plants grow faster in a soil-less environment because plant roots are not required to expend the energy to push soil particles, and therefore have more energy available for growing.

Two soil-less cultivation techniques are well disclosed in the prior art:

“Hydroponics” refers to one method of plant cultivation in which plants are grown in the absence of soil and roots are maintained in a substantially liquid environment. Instead of soil, the root mass of the plant is either supported within an essentially homogeneous synthetic or natural medium, which is either porous or particulate, or the root mass is immersed within a liquid, while the foliage of the plant is allowed to extend upward from the root support medium where it is exposed to light. Meanwhile, the root structure is exposed to a nutrient solution which may be either wicked up to the roots by means of a porous wicking medium or circulated by means of a pump irrigation system. Either way, nutrient delivery to the root mass may be carefully regulated.

“Aeroponics” refers to another soil-less method of plant cultivation which does not employ a means for supporting the roots in a liquid, or in a porous or particulate medium. In an aeroponic system, plants are supported over a chamber. The foliage of the plant extends upward from the outer surface of the chamber where it may be exposed to light and the roots extend downward into the chamber where they are suspended freely and are periodically exposed to a spray, forced mist, fog or other method of nutrient solution delivery. In an aeroponic system, nutrient delivery to the root structure of a plant may be even more carefully regulated than in a hydroponic system. Aeroponic systems provide a further advantage over other known cultivation systems. Since the root structure of the plant is constantly exposed to air, absorption of oxygen by the roots is optimized, thereby accelerating plant growth and improving plant health.

Soil-less media for growing plants are generally composed of materials that allow liquid nutrient solution to flow readily to plant roots and then to drain away so that roots are not constantly soaked in a liquid that may foster rot or the growth of damaging fungi. Soil-less media may be composed of any number of suitable porous substances such as peat moss, wood bark, cellulose, pumice, plastic or polystyrene pellets, vermiculite or foam, for example.

Various soil-less plant growth media are disclosed in the prior art:

For excample, Dedolph (U.S. Pat. No. 4,221,749) teaches a quantity of soil mixture particles distributed throughout a body of spongy polymer.

Moffet (U.S. Pat. No. 4,803,803) discloses a plant growth media “which comprises small tufts of mineral wool.”

Anton (U.S. Pat. No. 5,224,292) discloses a “non-woven mat comprising a layer of hollow synthetic organic fibers.”

Hsh (U.S. Pat. No. 5,363,593) discloses a synthetic cultivation medium comprised of scrap textile.

Kosinski (U.S. Pat. No. 6,555,219) discloses “a soil substitute” comprised of “biodegradable and non-biodegradable polymer fibers.”

All of these above-mentioned inventions provide a fibrous, filamentous or foam support for seed which allows water to pass through. While these disclosures offer an advantage over germinating seeds in soil alone, none of these references, taken alone or in combination offer the advantages of the present invention.

Seed germination is a particular concern in any soil-less cultivation system. Since the soil-less medium must adequately support the seed, the medium must be composed of a material firm enough to hold a seed, seedling or cutting in place until its root and stem structures can form, and yet it must contain characteristics of porosity and low water-retention so that seeds are not immersed in liquid.

A variety of soil-less, specifically seed-germinating media have been disclosed in the prior art. For example, Jones (U.S. Pat. No. 4,075,785) teaches a “discrete media of finite and substantially definite dimensions and having sufficient mechanical integrity and chemical stability to substantially withstand fracturing and degradation . . . as a seed implanted therein germinates and the resulting plant grows to commercial maturity.” Jones describes one such embodiment of this “discrete media” comprising a “peat pellet encased in perforated plastic.”

Dedolph (U.S. Pat. Nos. 4,221,749 and 4,495,310) teaches a “plant growth supporting rooting medium” comprised of polyurethane foam. This patent has been commercialized in the Chia® sponge and the Rapid Rooter® grow sponge, both of which permit seed germination within the sponge.

Nir (U.S. Pat. No. 4,332,105) teaches an “aeroponic plant growth and development medium especially suitable for the development of seeds, seedling or cuttings . . . comprising a support member formed of generally coplanar spaced sheets of screen material.” Alternatively, Nir teaches a “plurality of seed containing dishes” which are perforated to allow “its contents [to be] subjected to a mist.”

Fraze (U.S. Pat. No. 4,669,217) teaches “a self-containing nutrient plant propagation medium utiliz(ing) a sterile, low water retention, linear foam plastic” within which a seed may be placed for germination. This medium is placed into the “mounting surface” of a hydroponic system which contains holes sized for the medium.

More recently, Ishioka (U.S. Pat. No. 5,934,011) teaches “a seedling culture mat comprising a mat which comprises a fibrous substrate or a water-soluble film or paper.”

Otake (U.S. Pat. No. 6,240,674) teaches a porous sheet of foamed cells for raising seedlings on an industrial mass-production scale.

Each of these seed germination media may be used to hold a seed until implantation of the entire seed-bearing medium in either a soil-based or soil-less plant growth system. None of these above described disclosures provides the porous cup-shaped rigid outer receptacle containing a hydrophilic cellular substrate and a seed-bearing substrate of the present invention.

### SUMMARY OF THE INVENTION

It is an object of the present invention to provide an improved seed support medium suitable for transporting, supporting and germinating a seed in a soil-less environment.

It is a further object of the present invention to provide a three-part seed support and germinating system comprising a seed-bearing substrate superposed upon a hydrophilic cellular substrate contained within a porous, cup-shaped, structurally rigid modular receptacle.

It is a still further object of the present invention to provide a seed-bearing hydrophilic cellular substrate contained within a porous, cup-shaped, structurally rigid modular receptacle.

A significantly improved method for germinating a seed is also disclosed using this improved seed support medium in an aeroponic system.

The present invention provides adequate structural support for transporting and shipping the seed, as well as an appropriate germination and support system that can also be easily transplanted into either soil-based or soil-less growing environments at any point throughout the life cycle of the plant.

Additionally, the present invention also provides sufficient mechanical integrity to withstand degradation and to hold a seed or seeds firmly in place during packaging and shipment and through implantation of the seed into a growth system. In aeroponic and hydroponic systems, the present invention provides sufficient mechanical integrity to withstand degradation throughout the life of the plant, which may be as long as six months.

In aeroponic and hydroponic systems, it would be advantageous for the seed germination and support medium to be modular in design so that it may be easily implanted into a growth system and then later removed, whether for transplantation, harvest or termination of the plant. Mechanical integrity of the modular seed-germination and support unit is especially important.

Additionally, the present invention provides a seed germination and support medium which possesses sufficient wicking properties to enable water or liquid nutrient to pass through the medium to the seed and then to recede or evaporate so that the seed is not adversely affected by excess moisture. The present invention also contains sufficient nutrients to sustain the seed through the sprouting and rooting period. It also is composed of a material that allows roots to grow through it, while anchoring those roots firmly and retainig its shape.

Finally, the present invention provides a seed-germination and support medium which is sealed in order to regulate moisture during the germination process. Specifically, during germination the seal retains a necessary amount of moisture until such time as it is removed to allow light and air to reach the sprouting seedling. Also, the seal could be opaque in order to allow for “dark germination” of certain species of plant seeds.

### BRIEF DESCRIPTION OF THE DRAWINGS

FIG. 1 is a cross-sectional view of the preferred embodiment of the present invention.

FIG. 2 is a cross-sectional view of an alternative embodiment of the present invention.

### DETAILED DESCRIPTION OF THE INVENTION

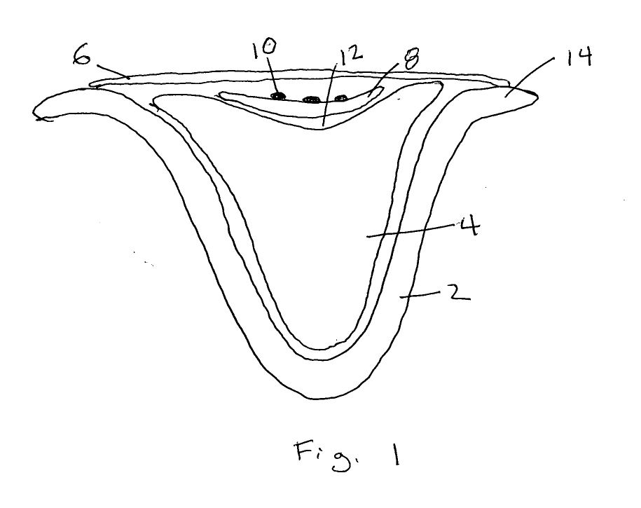

Turning now to FIG. 1, the preferred embodiment of the present invention is comprised of three distinct superposed components for carrying and germinating a seed and supporting the resulting plant. The most superposed seed-bearing substrate 8 is comprised of material formed from a pulp solution comprised of suitable fibers such as cellulosic material, for example, which upon drying provides a light-weight, stable, hydrophilic medium. The versatile pulp solution may be made to conform to any number of desired shapes, sizes or surfaces. Seeds 10 may be mixed into the pre-poured pulp solution, or they may be inserted superficially onto the poured solution. Once the pulp solution dries, the seed is trapped within or upon the substrate. In one embodiment of the invention, the substrate is first poured into a shaped, modular mold, then imbedded with seeds and allowed to dry. This dried modular unit is further imbedded into a cellular urethane substrate as depicted in FIG. 1.

In an alternative embodiment, a flat layer of pulp solution may be poured and then seeds are placed upon the wet substrate and allowed to adhere as the solution dries. The flat layer may then be cut into modular units. In still another alternative embodiment, seeds are mixed into a pulp formula prior to pouring. The seed-bearing pulp formula may be poured into a layer, allowed to dry and then cut into modular units, or the seed-bearing pulp formula may be poured into molds and allowed to dry into modular units. In each of these alternatives, the medium is made first, and then superposed upon a cellular urethane polymer substrate consolidated with select aggregate product. In the preferred embodiment, the pulp formula is poured directly into a concave recess in the cellular urethane polymer substrate and then allowed to dry.

Another embodiment of the most superposed seed-bearing substrate comprises an adhesive substance to which seeds will adhere and which itself will adhere to the intermediate hydrophilic cellular substrate. The hydrophilic cellular substrate 4 comprises the second superposed material. One suitable material is formed from a urethane pre-polymer reacted with an aqueous slurry of nutritive aggregate such as peat or bark, plus any number of desired adjuvants, such as fungicides, etc. In the preferred embodiment of the present invention, the cellular urethane polymer substrate containing nutritive aggregate product, adjuvant, fungicide, etc., is formed directly within a shaped, modular receptacle 2 of coir, hemp or other suitable natural or synthetic material, which durable modular receptacle constitutes the third distinct and outermost substrate of the present invention. Or, in another alternative embodiment, the pre-shaped cellular urethane polymer substrate 4 may be pre-formed and inserted “dry” into the shaped, modular receptacle 2. The hydrophilic cellular substrate 4 may also be composed of natural sponge, or any other suitable polymer. It may also be composed of rock wool or horticultural foam which is a rigid hydrophilic cellular polymer.

In either alternative embodiment regarding the hydrophilic cellular substrate 4, the top surface of that substrate will bear a concave recess 12 suitable for holding the seed-bearing substrate 8. The substrate 8 will be held within the concave recess 12 either by friction or by adhesion.

In the preferred embodiment of present invention, the third, outermost substrate 2 consists of a shaped, modular receptacle comprised of durable, hydrophilic fibers such as coir, hemp or other suitable natural or synthetic material. This durable unit is shaped into a tapered cup whose specific design and size may vary according to the type of plant cultivated, the duration of the cultivation cycle and the specifications of the particular growing system used. Suitable diameters of the unit range from about ¼ inch to about 4 inches or more. The outer rim of the durable cup-shaped unit is fashioned with an extra lip or ledge 14, which lip or ledge provides the stability necessary for supporting the entire plant grown in an aeroponic system. In general, the cup will taper inward, with the bottom of the cup having significantly smaller diameter than the lip. This taper provides easier transplanting and less root damage if the plant is transplanted to larger growing systems or into soil.

In an alternative embodiment, the shaped, modular receptacle is comprised of a rigid, water-permeable, hydrophobic medium such as molded plastic or metal mesh.

This unique modular seed support medium comprised of the three described components represents an improved seed-germination medium. The inventors have determined that this unique combination of substrates provides a distinct advantage for seed germination, especially in an aeroponic system, over any one of the substrates by itself. Each of the distinct components contributes uniquely and beneficially to seed germination, root growth and plant growth. The substrate 8 holds the seed 10 while controlling germination until a desired time when aqueous solution is applied to the substrate 8 in order to dissolve the substrate 8 and germinate the seed 10.

The hydrophilic cellular substrate 4 holds this seed-bearing substrate 8 while the seed 10 germinates. Most importantly, it provides a rooting substrate into which roots may attach and grow. This cellular substrate 4 further contains adjuvants that help to optimize plant growth. These adjuvants include nutrients such as calcium, phosphorous, and nitrogen, antifungals, anti-algals such as grapeseed extract, and beneficial bacteria, for example.

Furthermore, according to its design, the refined porosity of the cellular urethane substrate 4 controls delivery of moisture or aqueous nutrient solution and air both to the seed and especially to newly-sprouted plant roots.

However, the inventors have discovered that the cellular urethane substrate 4 alone does not possess sufficient mechanical integrity to support a plant for its entire life within an aeroponic system, nor is the cellular urethane substrate 4 particularly well-suited for packaging, shipment, implantation and transplantation because of its insufficient mechanical integrity. The inventors have determined that the fibrous, durable, rigid, outer cup-shaped substrate 2 provides the requisite rigidity, stability and durability to withstand packaging, shipment, implantation and transplantation, while protecting the more delicate nutritive cellular urethane substrate 4 and the seed substrate 8 it bears. Most essential for an aeroponic application, the durable, fibrous cup-shaped substrate 2 can be designed into a shape that will hold a plant firmly in place in an aeroponic system throughout the life of the plant. If desired, the rigid, cup-shaped substrate 2 will maintain its shape and stability sufficiently to enable removal of the entire seed germination medium, along with a partially or fully-matured plant, from an aeroponic or hydroponic system for transplanting into another medium such as soil.

Furthermore, this durable, outer substrate 2 helps to control moisture by contact with an aqueous nutrient solution, allowing transfer of that solution into the intermediate cellular urethane substrate, which itself transfers nutrient solution to a seed and then to young plant roots after germination. The coarseness of the material allows sufficient air to permeate the outer substrate and the intermediate cellular urethane substrate to aid in oxygenation of young plant roots. The coarse fibers may also allow air to evaporate excess moisture from the cellular sponge substrate 4. Adequate moisture will reach the seed to permit healthy germination even if this durable outer cup-shaped receptacle 2 is fashioned from a hydrophobic substance such as perforated plastic or a wire mesh. Coarse hydrophilic fibers provide the best substrate, however.

The seed-germination medium of the present invention is uniquely well suited for use in an aeroponic system. The modularity of the medium makes it ideally suited for implantation into and transplantation from the system. The durable modular unit of the present invention may be manufactured, packaged, stored for months and/or shipped to the consumer, who then simply has to unpackage the modular unit and insert it into a suitably sized hole in the surface of the aeroponic system. The consumer then needs merely to initiate the spray apparatus of the aeroponic system and the seed will germinate and grow without further attention. If the consumer wishes to utilize the aeroponic apparatus especially for seed germination, the durable, three-part medium of the present invention provides an ideal, transplantable seedling vessel. Finally, the modular unit is easily imbedded with any number of distinct varieties of seed, so that the entire unit may be conveniently labeled and identified. Certain nutrients may be absorbed into the cellular urethane layer or mixed into the pulp solution that optimizes the growth of a particular plant species. In addition, the air to water ratio of the cellular urethane layer can be adjusted to optimize the growth of particular species.

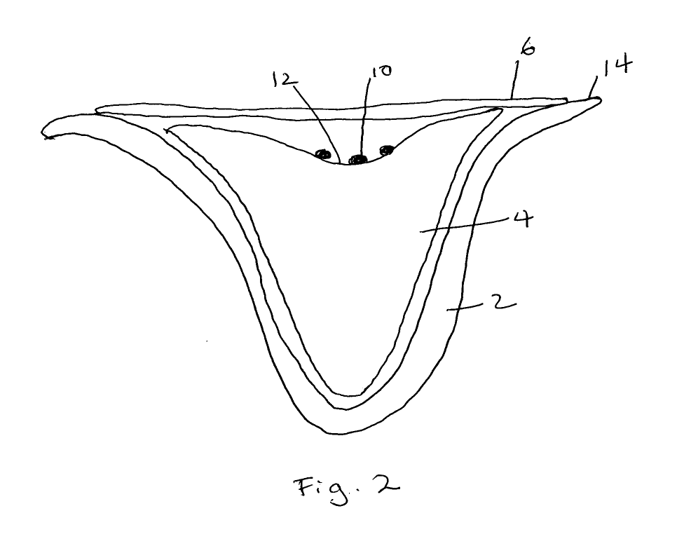

In an alternative embodiment of the invention shown in FIG. 2, only two distinct materials are used, namely a hydrophilic cellular substrate 4, which itself bears the seed 10, and the outer durable fibrous cup-shaped substrate 2. In this two-part embodiment of the invention, seeds 10 would be mixed into the aqueous slurry with which the urethane pre-polymer is reacted to form the cellular urethane 2. In this way the seeds become embedded into the sponge during its formation. Alternatively, the seed may be placed with some precision within subjacent layers of freshly formed cellular urethane. This second alternative is advantageous in that the placement and number of seeds within the sponge may be carefullly controlled. This separate, two-part embodiment of the invention is advantageous over the three-part embodiment in that it eliminates one step in creating and inserting the seed-bearing substrate 8 into the cellular urethane substrate 4, providing a simpler, more stable final product. However, the cellular urethane layer 4 may retain excess moisture, thus encouraging rot. In either the two-component or the three component seed-support medium described above, an additional seal 6 composed of a plastic, a metal foil or paper may be superposed upon the rim of the durable cup-shaped receptacle 2 in order to further benefit the seed 10. During storage and shipment, the seal 6 helps to preserve the mechanical integrity of the modular unit. After implantation of the seed 10 into a growing system, such as an aeroponic system, moisture will be applied to the inferior portion of the unit, namely the porous, cup-shaped receptacle 2. The seal 6 provides an additional advantage at this particular time in the growth cycle by trapping moisture within the unit and preventing evaporation until such time as the seed has effectively begun to germinate. It is advantageous, therefore, that the seal be comprised of a material that is impermeable to water. The seal 6 may then be conveniently removed to allow for the growth of the plant. Certain seeds germinate best in the dark, while others require light. Therefore, the seal 6 may be comprised of either an opaque substance or a transparent substance, or even a translucent substance, depending on the needs of a particular seed and plant species. The seal 6 also serves as a convenient label for each modular unit, describing what species of seed is contained therein and precise instructions for germination.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A seed-support medium comprising:
a) a seed-bearing substrate superposed upon
b) a hydrophilic cellular substrate contained within
c) a porous, cup-shaped, rigid modular receptacle.

2. The medium of claim 1 wherein the seed-bearing substrate is a hydrophilic fiber.

3. The medium of claim 1 wherein the seed-bearing substrate is plant starch.

4. The medium of claim 1 wherein the seed-bearing substrate is an adhesive.

5. The medium of claim 1 wherein the seed-bearing substrate further comprises adjuvants.

6. The medium of claim 1 wherein the hydrophilic cellular substrate is a synthetic polymer.

7. The medium of claim 1 where the hydrophilic cellular substrate is sponge.

8. The medium of claim 1 where the hydrophilic cellular substrate is rock wool.

9. The medium of claim 1 where the hydrophilic cellular substrate further comprises adjuvants.

10. The medium according to claim 1 which further comprises a seal.

11. The medium of claim 10 wherein the seal is opaque.

12. The medium of claim 10 wherein the seal is transparent.

13. The medium of claim 10 wherein the seal is translucent.

14. A seed-support medium comprising:
a) a seed-bearing hydrophilic cellular polymer substrate contained within
b) a porous, cup-shaped, modular rigid receptacle.

15. The medium according to claim 14 where the hydrophilic cellular substrate is a synthetic polymer.

16. The medium according to claim 14 where the hydrophilic cellular substrate is sponge.

17. The medium according to claim 14 where the hydrophilic cellular substrate is rock wool.

18. The medium according to claim 14 where the hydrophilic cellular substrate further comprises adjuvants.

19. The medium according to claim 14 which further comprises a seal.

20. (canceled)
